(19) United States
(12) Patent Application Publication
(10) Pub. No.: US 2022/0302700 A1
(43) Pub. Date: Sep. 22, 2022

(54) DC VOLTAGE REGULATION BY INDEPENDENT POWER CONVERTERS

(71) Applicant: Arda Power Inc., Oakville (CA)

(72) Inventor: Luis Zubieta, Oakville (CA)

(73) Assignee: Arda Power Inc., Oakville (CA)

(21) Appl. No.: 17/715,680

(22) Filed: Apr. 7, 2022

Related U.S. Application Data
(63) Continuation of application No. 16/610,737, filed on Nov. 4, 2019, now abandoned.
(60) Provisional application No. 62/501,158, filed on May 4, 2017.

(51) Int. Cl. H02J 1/12; H02J 1/10; H02J 1/04; H02J 1/06; H02J 1/14; H02J 7/34; H02M 3/158

(52) U.S. Cl. CPC H02J 1/12; H02J 1/106; H02J 1/04; H02J 1/06; H02J 1/102; H02J 1/14; H02J 7/34; H02M 3/1584

(57) ABSTRACT

In a system composed of at least two components joined by a common DC bus, a method to regulate the common DC bus and share the regulation of the DC bus between two or more elements connected to the DC bus through power converters by: implementing a first controller on each converter to introduce a virtual resistance or droop at the terminals of the converter that are connected to the bus being regulated; and implementing a second controller to regulate a second variable different from the common DC bus voltage where the output of the controller is used to shift the virtual resistance curve up and down.

### CROSS-REFERENCE TO RELATED APPLICATION

This application is a continuation application based on U.S. patent application Ser. No. 16/610,737, filed Nov. 4, 2019, entitled “DC Voltage Regulation by Independent Power Converters” which is based on International PCT Patent Application No. PCT/CA2018/050372 filed Mar. 27, 2018 which claims the benefit of U.S. Provisional Patent Application Ser. No. 62/501,158, filed May 4, 2017.

### BACKGROUND OF THE INVENTION

### 1. Field of the Invention

This invention is associated with the use of multiple independent power converters to control a common DC bus voltage.

### 2. Prior Art

In systems where multiple resources, loads, and storage elements are connected through a common DC bus, it is typical to interface the different components through power converters like it is represented in FIG. 1. In this case, the DC bus can be regulated by one or several power converters. For small and simple systems, one of the power converters is used to regulate the voltage while the rest draw or inject power to the common regulated bus.

For higher power installations, it may not be cost effective or physically possible to use a single converter for regulating the DC voltage. The need for productization and modularity usually dictates that a few standard converter sizes are used to cover the full range of sizes of projects by connecting multiple converters in parallel. In addition, some installations could require that multiple different resources, each one interfaced with its own converter, must be used simultaneously and in a coordinated way to regulate the DC voltage. Therefore, it is necessary to find simple, reliable, and scalable ways to use multiple power converters to regulate the DC bus voltage.

A master/slave scheme using fast communication amongst the master and the slaves can be used to realize the control of the common bus by multiple power converters. Faster dynamics of the controlled voltage because of larger power transients and/or smaller power filters result in large bandwidth communication requirements.

For larger installations, the cost of slowing the dynamics of the system to allow using the communication speeds presently available is prohibitive. Furthermore, using fast communications removes flexibility to the concept as it requires large engineering effort for each installation as the dynamics, size, and rating of the components change.

Another method used to regulate the voltage with multiple energy resources is realized by switching on and off the different converters depending on the voltage and power conditions. This method demands high response from the different components and it is affected greatly by the tolerances in the voltage measurements amongst the different devices. Furthermore, the concept requires large amount of reengineering if the dynamics of the system are changed to ensure stability during the transitions.

A more flexible method used to control a voltage common to multiple converters is to use so-called droop technologies where a virtual resistance is introduced at the output of each power converter by its internal controller. Each converter operates as if a resistor is placed at its output but without the losses associated to a physical resistance. The voltage set point followed by each converter is then given by the following equation:

Vsp=Vo−K Iout (1)

Where Vo is the nominal voltage value being controlled, K is the value of the virtual resistance, and Tout is the current into the common DC voltage bus from the corresponding converter with positive values representing power injected to the bus. In many implementations, the converter current Tout is replaced by the processed power Pout since for a quasi constant DC voltage the two quantities are proportional. The virtual resistance provides a stable operating point for all the converters responsible for the voltage regulation while maintaining the controlled voltage within the range given by virtual resistance value. This concept was originally developed to share the load while regulating the voltage in systems using multiple unidirectional converters. Using the same value of virtual resistance for all the converters provides good sharing of the load amongst the different power converters controlling the bus. If unequal percentage of contribution is needed from each converter, different virtual resistance values can be used for the different converters.

This method can be easily extended to bi-directional systems by simply allowing the current to be negative in equation 1. However, circulating currents amongst the different elements because of tolerances in the individual voltage sensing represent a challenge when using the droop in bidirectional systems. These circulating currents affect the efficiency and, in some cases, difficult the stabilization of the system during low load operation. A trade off between the magnitude of the virtual resistance and the accuracy of the load sharing is necessary in classical droop methods. In addition, when there are individual and different operating requirements for each converter, and these requirements change over time, the classic virtual resistance method does not allow to address these individual requirements.

Improved methods can achieve regulation of the bus by multiple converters based on the droop method but adding a voltage margin. The voltage margin basically creates a discontinuity in the droop function where the converters operate in constant power mode. By moving the location of the voltage margin in power, the power of each converter could be adjusted to fulfill an internal requirement such as battery management. However, these methods require that a main converter is still responsible for regulating the bus in most conditions instead of sharing the task, it also presents challenges when this main controller is not able to regulate the bus anymore as one or several of the other converters must change operating mode quickly.

### SUMMARY OF THE INVENTION

Forming one aspect of the invention is a system composed of at least two components joined by a common DC bus, a method to regulate the common DC bus and share the regulation of the DC bus between two or more elements connected to the DC bus through power converters by: implementing a first controller on each converter to introduce a virtual resistance or droop at the terminals of the converter that are connected to the bus being regulated; and implementing a second controller to regulate a second variable different from the common DC bus voltage where the output of the controller is used to shift the virtual resistance curve up and down.

### BRIEF DESCRIPTION OF THE DRAWINGS

FIG. 1 shows a prior art power converter;

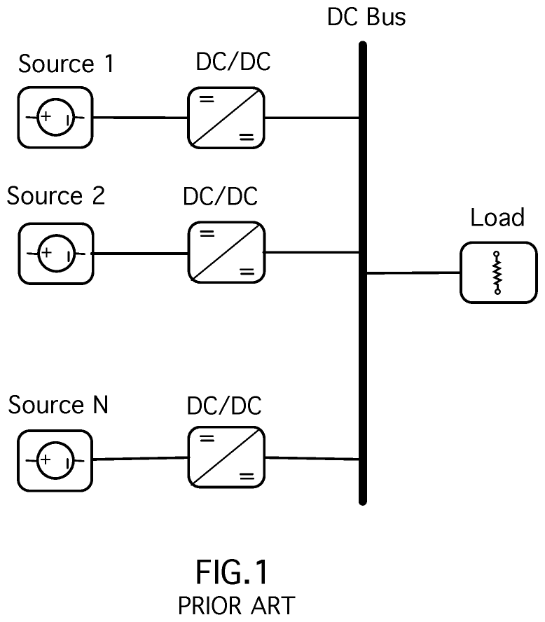

FIG. 2 shows a slow controller to generate load voltage;

FIG. 3 shows the implementation of a droop curve and fast voltage controller for an energy storage device;

FIG. 4 shows voltage set point v. power for a theoretical converter;

FIG. 5 shows a DC system having three energy storage units;

FIG. 6 shows the current from each energy storage unit of FIG. 5;

FIG. 7 shows the no load voltage for the droop characteristic for each energy storage as well as controlled bus voltage;

FIG. 8 shows the current from each energy storage unit pre- and post-power step; and

FIG. 9 shows the no load voltage for each energy storage.

### DETAILED DESCRIPTION OF THE PREFERRED EMBODIMENTS

In the droop method for bidirectional converters, the power provided by each converter depends on the voltage imposed on the common bus by other elements and the internal no load voltage Vo in equation (1). Assuming Vo is identical for all the converters, under no load conditions on the bus, all the converters operate at zero power and with their terminal voltages at Vo. If one of the converter has the value of Vo higher, it will source power that will be sunk by all the other converters.

The voltage regulation operates automatically by converging to the stable points in the droop characteristics independent of small differences in Vo.

In the proposed method, each power converter controller operates in voltage control mode and uses a virtual resistance or droop function to calculate its voltage set point as in the classical droop method. However, the droop function is shifted by changing the value of Vo to adjust the converter power and fulfill internal operating constrains for the element associated with that converter. By shifting the droop function, a converter can modify its power contribution to the voltage control as it gives or takes part of the power to/from another converter. If the droop curve is shifted upwards (Von increased), that converter will provide more current or demand less current. If the droop curve is shifted downward (Von decreased), the converter will provide less current or demand more current. It is possible that at the same time one of the bidirectional converters is supplying power to the common bus while another is taking power from the bus in a controlled manner giving each converter the possibility to execute its internal power and energy requirements.

The voltage set point for a converter “n” participating on the voltage regulation is given by (2).

Vspn=Vovn+Kn Ioutn (2)

where Vspn is the voltage set point, Kn is the virtual resistance, Ioutn is the measured output current, and Von is the variable no load voltage.

In classical droop method, differences in Von amongst converters are the result of tolerances in the instrumentation and detrimental to the performance of the voltage regulator or the current sharing. In the proposed method, the system takes advantage of variations in this internal value to achieve a local control objective. To provide good voltage regulation and a stable and robust operation, the controller should provide fast regulation of the terminal voltage based on the instantaneous current and droop equation, while the adjustment of Vo should be slower.

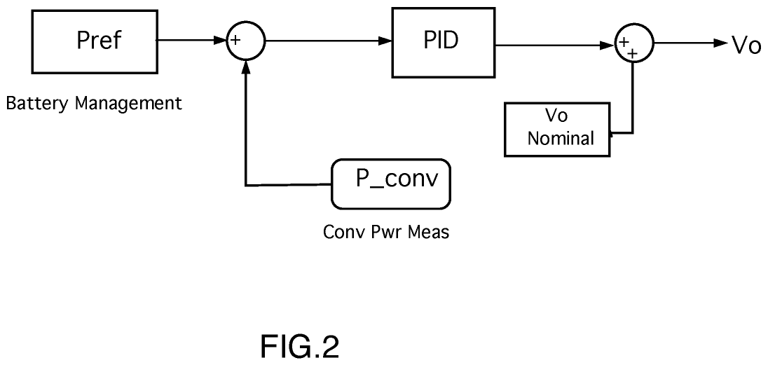

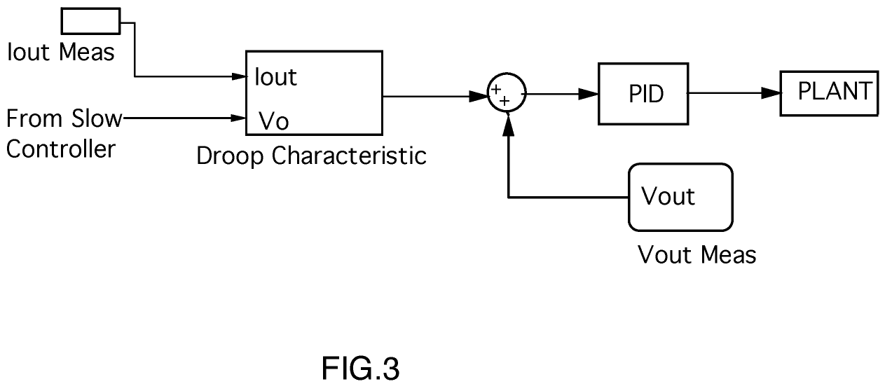

The adjustment of Von to shift the droop function is decided by each converter based on internal requirements and independently of other converters or elements connected to the common DC bus. This makes the system flexible and scalable with minimum amount of reengineering. One possible use of the concept is when multiple converters interconnect energy storage devices to a common DC bus. In this case, the battery management provides a useful operating power for the battery based on their state of charge and other internal conditions. This power reference is then used as a reference for a slow controller that produces as output the no load voltage Vo. The no load voltage then is incorporated to the droop characteristic and the fast voltage controller. FIG. 2 shows the implementation of the slow controller to generate the Vo and FIG. 3 represents the implementation of the droop curve and the fast voltage controller for an energy storage device.

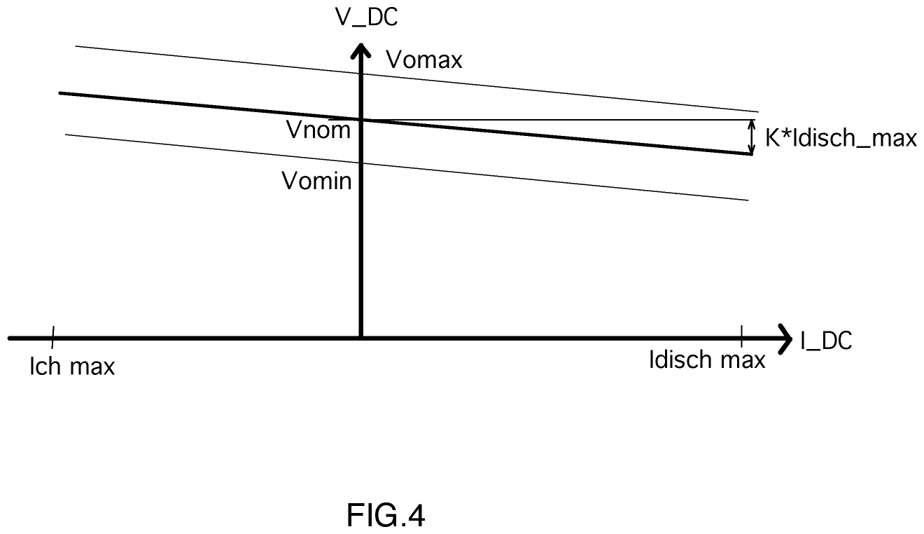

Another feature of the sliding droop concept is that the different power components can be prioritized to respond to power transients by using different slopes of the virtual resistance. This means that if two converters CNV1 and CNV2 with similar conditions are programmed such that CNV1 has lower virtual resistance, CNV1 will respond initially with a larger percentage of power to compensate for a power step. However, if the converter CNV1 is not capable to operate at this high power for long time, it would change its value of no load voltage (Vo) to transfer the power to CNV2 that did not have the fast response capability but that is more capable of carrying the load for larger periods. The range of change for the no load voltage Vo should be limited in coordination with the virtual resistance value to maintain the bus voltage within the specified range of operation. FIG. 4 shows the voltage set point vs power characteristic for one theoretical converter showing the band from Vomin to Vomax where the no load voltage set point can be shifted while maintaining the virtual resistance K.

Use of Sliding Voltage Droop in a System with Multiple Energy Storage Devices

One practical application of the concept is a system where multiple energy storage devices are used to store or provide power to a common DC bus.

One possible operating mode would be to use all the energy storage converters in conjunction to control the bus. However, in addition to controlling the bus, each converter needs to execute an energy management algorithm to ensure its energy storage device is operating within its specifications. It is conceivable that some storage components will have high power capability but low energy (cannot maintain the power for long periods), while others may have high current capability but being unable to handle fast power transients, a third potential group may be able to produce limited power but for very long time.

In this case, to optimize the operation of the energy storage devices, it would be necessary to sequence how the different storage units respond to a sudden change in load, and to have a mechanism to transfer load from one energy storage device to another. All this while maintaining the DC voltage regulated.

To fulfill these requirements, power converters serving energy storage devices with high power transient capability are programmed with lower virtual resistance while the ones serving energy storage devices with lower power capability are programmed with larger virtual resistance. The practical result is that when a change in total power is necessary to maintain the DC voltage, the converters with the lower virtual resistance will take a larger percentage of this change while the converters with larger virtual resistance will take a lower percentage of the load change.

In addition, if the internal energy management algorithm of energy storage unit n is requesting for that device to be recharged, its power converter will start shifting down the value of no load voltage (Von). A lower value of Von means that power presently provided by this converter n will be shifted to one or several other converters interfacing energy storage units that have larger energy stored at that moment. If all the energy storage devices are getting low in energy, a separate energy management function would have to either increase the power generation or reduce the power consumption but that is independent of the DC voltage control and of the power management discussed in this document.

Even if using the same type and rating of energy storage device, the different storage devices would have differences and tolerances and they would also age at different rates making it necessary to execute separate and individual energy management functions to maximize the performance of the installation while avoiding over charging or over discharging some of the storage devices. The sliding droop concept provides this functionality.

Simulation of an Installation with Three Different Energy Storage Devices

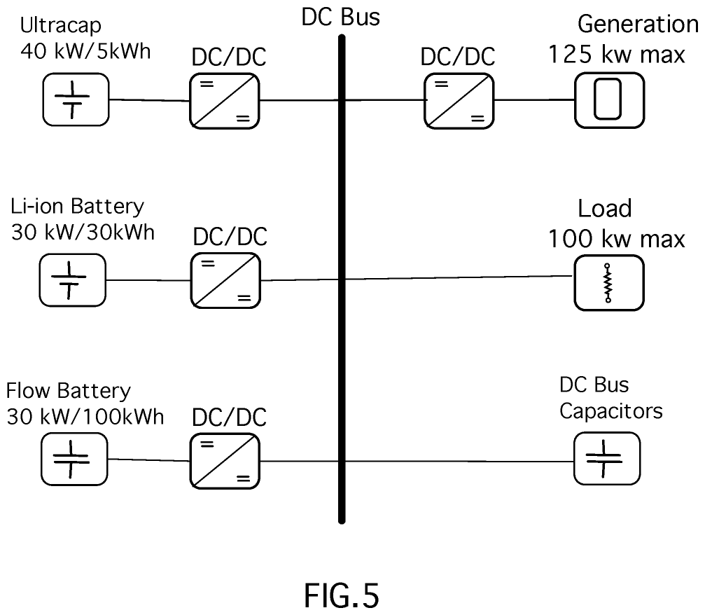

FIG. 5 shows a potential DC system where three different energy storage units are used to execute multiple energy functions while regulating the DC voltage.
The first energy storage element is an ultra-capacitor capable of providing 40 kW of power and storing 5 kWh of energy. This device is used to provide the power during sudden and frequent load steps such as starting and stopping a cooling system or an industrial machine. Its energy management operates by keeping the state of charge at 50% as much as possible so that the device is available to source or sink load when necessary.
The second energy storage element is a Lithium-Ion battery that can provide 30 kW of power and store 30 kWh of energy. This device is used to provide power for a duration of between several minutes and several tens of minutes in applications such as solar or wind peak shaving, AC grid frequency or voltage support through an inverter, or short term emergency power. The goal of its energy management is to maintain the state of charge between 30 and 70%. Furthermore, to minimize the number of cycles, the Lithium-Ion battery takes a second priority in response to sudden power transients.
The third energy storage element is a flow battery capable of providing 30 kW of power and to store 100 kWh of energy. This device is used to store energy for larger periods, in the order of hours, in applications such as peak shifting or load following. The energy management in this case has as main goal to maintain the state of charge for the device between 10% and 90% and limited to limited power changes. Therefore, it has the lowest priority in responding to sudden power transients.

The three storage elements are joined through power converters to a common DC bus rated at 760 VDC. Renewable and traditional power sources rated at a peak power of 125 kW are also feeding the DC bus and loads peaking at 100 kW with a minimum loading of 25 kW are fed from the DC bus. The following table summarizes the settings for the converters coupling the three energy storage elements:

| | Ultracap | | Lithium-Ion | | Flow | |
|---|---|---|---|---|---|---|
| Rated Bus Current | 53 | A | 40 | A | 40 | A |
| Virtual Resistance | 0.1 | V/A | 0.4 | V/A | 1.2 | V/A |
| Droop Band | +/−70 | V | +/−50 | V | +/−20 | V |

The system was modelled in MATLAB/Simulink. Two simulation cases are presented in this paper:

### Small Power Step

In the first case, the system is running with 105 kW of generation and 100 kW of load in other words 5 kW of power are flowing into the batteries. The Lithium-Ion battery is low in charge, and as a result, its battery management is requesting to recharge the battery. The flow battery has large capacity available for discharging or charging if needed. The simulation is initialized with most of the 5 kW of battery power being delivered to the Lithium-Ion battery and the system stabilized. A time t=60 seconds, there is a sudden reduction in generated power dropping to 80 kW. This means that the energy storage elements as a group must now provide 20 kW of power to regulate the DC bus.

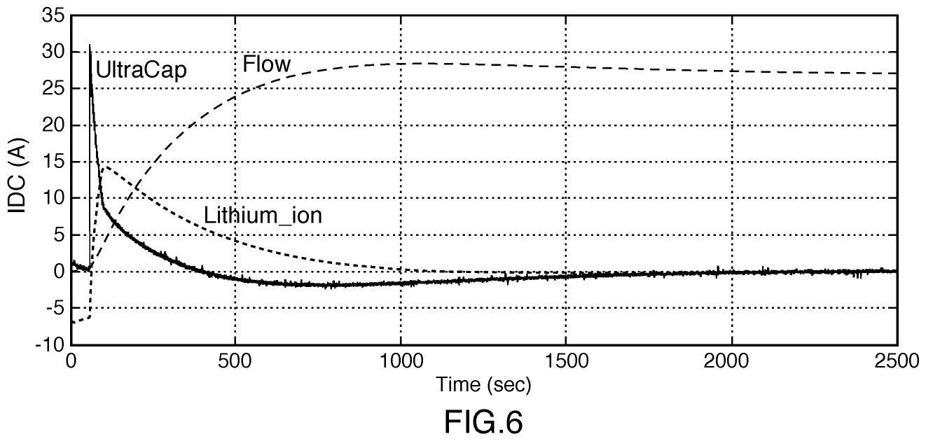

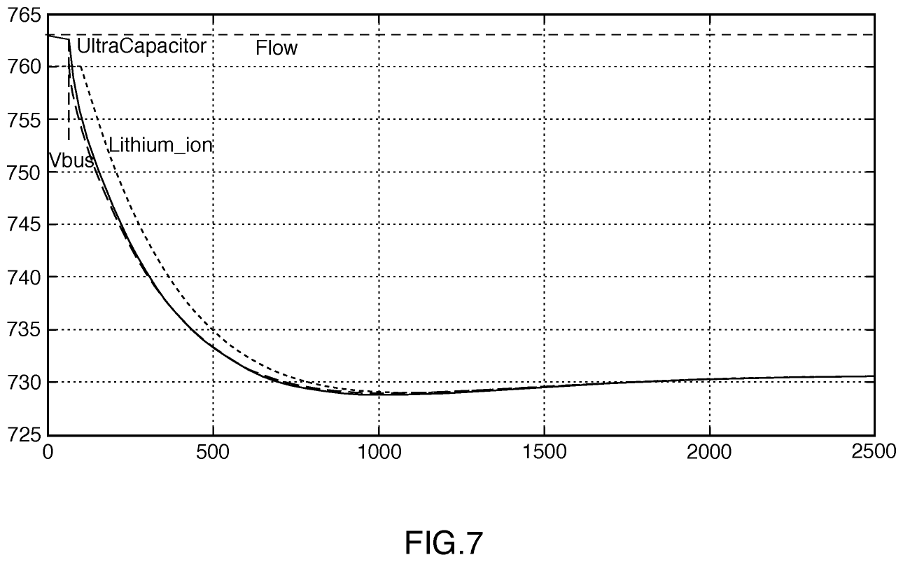

FIG. 6 shows the current from each energy storage unit just before and several minutes after the power step, and FIG. 7 shows the no load voltage for the droop characteristic for each energy storage as well as the controlled bus voltage. The ultracapacitor takes more of the load immediately after the transient. Then, its slow controller starts shifting Vo down and the power starts shifting from the ultracapacitor to the other two energy storage elements and mainly to the Li-Ion battery. Since the Li-Ion energy management is commanding to recharge the battery, its slow controller starts shifting that Vo down and most of the power goes to the flow battery. After a few minutes, the ultracapacitor current changes direction and it starts recharging the device again with a small current to recover the 50% state of charge goal. At the end of the simulation the ultracapacitor is back to 50% charge and the li-Ion battery is not discharging anymore, while the flow battery has taken over all 20 kW of power required to maintain the DC bus. Note that during the full transient, the DC voltage remains controlled by the batteries and only a small and short disturbance is observed immediately after the transient.

### Large Power Step

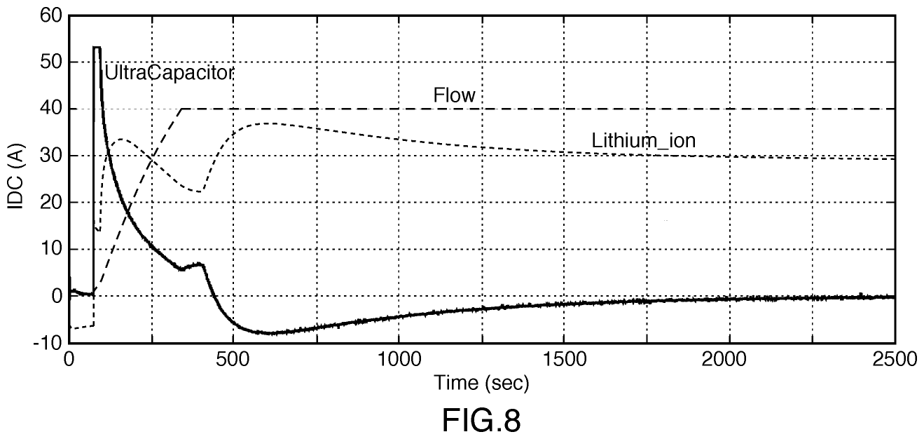

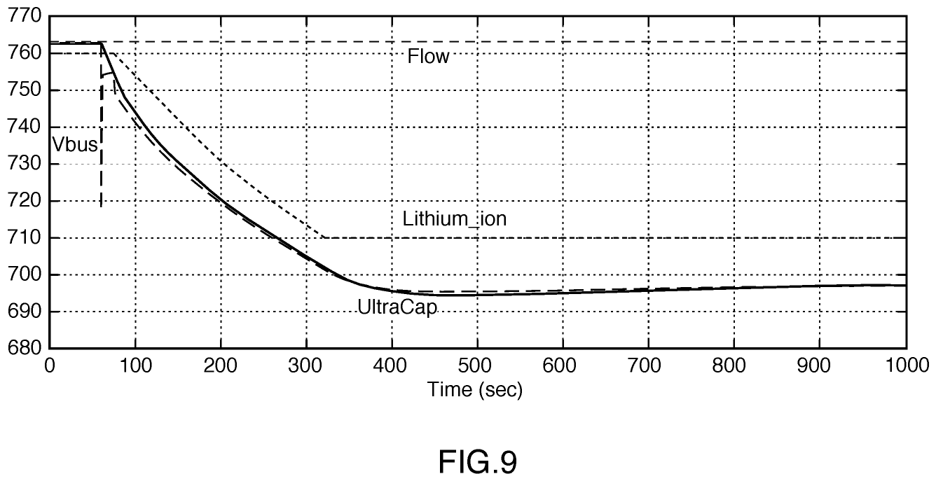

In the second simulation case, the initial conditions are the same as in the first case, but at t=60 seconds, the generated power drops to 50 KW. This means that the storage elements must provide 50 kW of power to regulate the DC bus. FIG. 8 shows the current from each energy storage unit just before and several minutes after the power step, and FIG. 9 shows the no load voltage Vo for each energy storage as well as the controlled bus voltage. As in the previous case, the ultracapacitor takes most of the power initially. However, the ultracapacitor power capability is not sufficient to support the load step and the difference must be carried by the other two batteries based on their virtual resistance values.

Soon after the transient, the power is shifted to the Lithium-Ion and flow batteries by the ultracapacitor Vo controller. The Lithium-ion battery Vo controller starts shifting trying to take the battery back to recharging operation. However, in this case, the power capability of the flow battery is not enough to maintain the DC bus by itself and it clamps at the maximum current. The lithium-ion battery is forced to provide power as part of the voltage regulation and it cannot follow its internal battery management request for recharging.

As a result, a high-level energy manager would have to shave part of the load or start additional generation to be able to continue operation without fully discharging the energy storage units. The ultracapacitor having a larger band for Vo, is still able to get recharged to 50% state of charge as commanded by its energy manager.

FIG. 9 also shows that the initial voltage transient is increased due to the larger power step but it is still within the normal range of voltage. The Li-Ion Vo controlled saturates to its minimum value but due to the high power needs it is not able to recharge the battery as mentioned before. Note that in both simulation the value of Vo for the flow battery remains unchanged as this battery has enough energy stored and its slow controller enables continued operation without additional action.

What is claimed is:

1. A method for use with a DC bus and two or more elements, each element of said two or more elements being connected to the DC bus through a respective power converter having terminals, which method comprises:
implementing a first controller on each converter to introduce a voltage droop at the terminals of the converter; and
implementing on at least one of the converters, a second controller, wherein the output of the second controller is actively modified to shift the droop curve of the first controller and down responsive to the state of the element to which the first converter is coupled.

2. The method of claim 1 where the two or more elements are capable to process bi-directional power.

3. The method of claim 2 where at least one of the two or more elements is an energy storage element.

4. The method of claim 2 where the converter on which the second controller is implemented is coupled to a battery and the second controller executes battery management for the battery.

5. The method of claim 1 where the controllers introduce virtual resistances at the terminals, the resistances having differing values.

6. The method of claim 1 where the converters include DC/DC converters and AC/DC converters.

7. The method of claim 3 where the DC bus and the elements form part of a microgrid.
